(19) United States
(12) Patent Application Publication
(10) Pub. No.: US 2009/0074929 A1
(43) Pub. Date: Mar. 19, 2009

(54) METHOD FOR PRESERVING FOOD STERILIZED BY HEATING

(75) Inventors: Tomonori Kato, Kanagawa (JP); Ryoji Otaki, Kanagawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Mitsubishi Gas Chemical Company, Inc.

(21) Appl. No.: 12/208,366

(22) Filed: Sep. 11, 2008

(30) Foreign Application Priority Data
Sep. 14, 2007 (JP) 239092/2007

(51) Int. Cl. A23L 3/00

(52) U.S. Cl. 426/398

(57) ABSTRACT

A method for preserving food to be sterilized by heating which comprises sealing the food by using a multilayer container and a cap part and sterilizing the food by heating at 80° C. or higher, wherein the container has a layered structure having three or more layers in which a layer comprising polypropylene as the main component, an adhesive layer comprising an adhesive thermoplastic resin and a gas barrier layer comprising a polyamide resin having substantially no hydroxyl group are laminated in this order, and the cap part has a gas barrier layer.

### TECHNICAL FIELD

The present invention relates to an excellent method for preserving food sterilized by heating. More particularly, the present invention relates to a method for preserving food by which excellent antioxidation property and resistance to moisture are obtained and the best-before date of the food can be extended by preventing color change and discoloration of the food during the sterilization by heating and the storage.

### BACKGROUND ART

As the method for preserving food sterilized by heating, heretofore, the food is packed in a can since degradation, color change and discoloration during sterilization by heating and storage must be prevented. When the food is packed in a can, excellent effect is exhibited on the gas barrier property to various gases such as oxygen and water vapor. However, the method of packing the food in a can has drawbacks in that the content cannot be visually identified before the can is opened, that the heating treatment using a microwave oven is not possible, that it is not easy that the food is taken out freely for arranging food on plates, and that it is difficult that empty cans are placed upon another to save the space and this difficulty causes a problem on disposal in the appropriate way due to the bulkiness.

As the container for preserving food to replace the can, heat molded containers made of thermoplastic resins are widely used. In particular, containers made of polypropylene (occasionally, referred to as PP, hereinafter) are widely used as the container for preserving food which must be subjected to the retort treatment since PP has a melting point higher than the temperature of sterilization by the retort treatment. However, PP has the property such that oxygen which causes degradation, color change and discoloration of food permeates through PP easily although PP exhibits excellent resistance to moisture. Therefore, the container made of PP is insufficient as the container for preserving food for a long period of time.

As the method for enabling the food to be preserved in a container made of PP for a long time, a method in which a multilayer container having a layer of a thermoplastic resin exhibiting the barrier property to oxygen as an intermediate layer is used, is known. As the resin constituting the gas barrier layer, an ethylene-vinyl alcohol copolymer (occasionally, referred to as EVOH, hereinafter) is known. EVOH is a resin exhibiting the excellent barrier property to oxygen and widely used for containers for preserving various foods for a long time. However, EVOH has a drawback in that the moisture dependency of the barrier property to oxygen is great due to hydroxyl group in the composition of the barrier resin. In particular, when food which must be sterilized by heating at 100° C. or higher is contained and preserved, the multilayer container using EVOH for the gas barrier layer shows a great decrease in the barrier property to oxygen during sterilization by heating since the container is exposed to heated water or steam for certain time during sterilization by heating. Moreover, the barrier property to oxygen of EVOH remains decreased to a great extent after the sterilization is completed. Although the barrier property to oxygen returns to the original condition with passage of time, it takes a long time to completely recover the original property. Permeation of a great amount of oxygen takes place before the original property is restored, and the problem remains on the property for preserving food sterilized by heating.

As the thermoplastic resin exhibiting the excellent barrier property to oxygen other than EVOH, poly-meta-xylylene adipamide (occasionally, referred to as N-MXD6, hereinafter) is known, and a multilayer container using N-MXD6 in combination with PP is disclosed (refer to Patent Reference 1). Poly-meta-xylylene adipamide is a polyamide resin obtained by polycondensation of meta-xylylenediamine and adipic acid. N-MXD6 has the characteristic that the moisture dependency is smaller than that of EVOH since no hydroxyl group is present in the resin composition, and the decrease in the barrier property to oxygen during the sterilization by heating is small. Therefore, the amount of permeation of oxygen into the container can suppressed with N-MXD6, and the property for preserving food sterilized by heating can be improved. However, since the rate of crystallization of N-MXD6 is very fast at 150 to 180° C. at which PP is molded by heating, N-MXD6 has drawbacks in that fracture, formation of uneven thickness and whitening take place in the layer of N-MXD6 and that properties such as the gas barrier property, the transparency and the shape become poor.

For obtaining a multilayer container of PP using N-MXD6 for an intermediate layer, it is necessary of making lower the rate of crystallization of N-MXD6. For this purpose, a method in which a hardly crystallizing or non-crystallizing polyamide resin is mixed with N-MXD6 (refer to Patent Reference 2) and a method in which an aromatic dicarboxylic acid as the third component is copolymerized with N-MXD6 (refer to Patent Reference 3), are disclosed. However, when a hardly crystallizing or non-crystallizing polyamide resin is mixed with N-MXD6, the gas barrier property of the obtained multilayer structure decreases since a polyamide resin exhibiting the gas barrier property inferior to that of N-MXD6 is mixed. Therefore, the method of mixing a hardly crystallizing or non-crystallizing polyamide resin with N-MXD6 has a problem in that degradation, color change and discoloration of food take place at portions of the container having a smaller thickness such as corner portions. The method of copolymerizing an aromatic dicarboxylic acid as the third component with N-MXD6 has a problem in that adjustment of the melt viscosity of a composite with PP used as the material for forming the multilayer container is difficult when the amorphous property of the material containing N-MXD6 is excessively enhanced.

As described above, a satisfactory method for preserving food sterilized by heating has not been obtained even when a container of PP having a gas barrier layer as an intermediate layer is used.

[Patent Reference 1] Japanese Patent Application Publication No. Showa 56(1981)-23792

[Patent Reference 2] Japanese Patent Application Laid-Open No. Heisei 1(1989)-141737

[Patent Reference 3] Japanese Patent Application Laid-Open No. Heisei 6(1994)-287298

### DISCLOSURE OF THE INVENTION

The present invention has an object of overcoming the above problems and providing a method for preserving food sterilized by heating by which color change and discoloration during storage of the food sterilized by heating is prevented by using a container for preservation which comprises a multilayer container of PP and a cap part exhibiting the advantageous gas barrier property as the packaging materials for food which must be sterilized by heating, and the best-before date of the food can be extended.

As the result of intensive studies by the present inventors on the method for preserving food sterilized by heating, it was found that the excellent property for preserving food could be exhibited even after sterilization by heating at 80° C. or higher when the food was sealed by using a multilayer container of PP and a cap part, wherein the multilayer container was obtained by laminating as the gas barrier layer a polyamide resin obtained by polycondensation of a diamine component containing 70% by mole or more of meta-xylylenediamine and a dicarboxylic acid component containing 80 to 97% by mole of an α,ω-linear aliphatic dicarboxylic acid and 3 to 20% by mole of an aromatic dicarboxylic acid, and the cap part had a gas barrier layer having a permeability of oxygen of 20 ml/m²·day·atm or smaller under an environment of 23° C. and 60% RH. The present invention has been completed based on the knowledge.

The present invention provides a method for preserving food sterilized by heating which comprises:

sealing the food by using a multilayer container having a layered structure having at least three layers comprising (A) a layer comprising polypropylene as a main component, (B) an adhesive layer comprising an adhesive thermoplastic resin and (C) a gas barrier layer comprising a polyamide resin, which is obtained by polycondensation of a diamine component comprising 70% by mole or more of meta-xylylenediamine and a dicarboxylic acid component comprising 80 to 97% by mole of an α,ω-linear aliphatic dicarboxylic acid and 3 to 20% by mole of an aromatic dicarboxylic acid and has substantially no hydroxyl group, layers (A), (B) and (C) being laminated in this order, and a cap part comprising a gas barrier layer having a permeability of oxygen of 20 ml/m²·day·atm or smaller under an environment of 23° C. and 60% RH; and

sterilizing the sealed food by heating at 80° C. or higher.

### THE MOST PREFERRED EMBODIMENT TO CARRY OUT THE INVENTION

By the method of the present invention, color change and discoloration of food during storage of food sterilized by heating can be prevented, and the best-before date can be extended. Moreover, since the method of the present invention exhibits excellent property for preserving food having the retort treatment, the convenience of customers is improved by using the foods preserved in accordance with the method of the present invention as a substitute for canned foods, and the industrial value of the method is very great.

In the multilayer container used in the present invention, at least three layers which are (A) a layer comprising polypropylene as the main component (a PP layer), (B) an adhesive layer comprising an adhesive thermoplastic resin and (C) a gas barrier layer comprising a polyamide resin obtained by polycondensation of a diamine component comprising 70% by mole or more of meta-xylylenediamine and a dicarboxylic acid component comprising 80 to 97% by mole of an α,ω-linear aliphatic dicarboxylic acid and 3 to 20% by mole of an aromatic dicarboxylic acid and having substantially no hydroxyl group are laminated in this order. As the multilayer container, it is sufficient that the three layers described above are laminated in this order. An intermediate layer may be laminated between the above layers. An adhesive layer, a PP layer and a layer comprising another resin may be laminated on the outside of the laminate of the three layers.

The cap part used in the present invention has a gas barrier layer having a permeability of oxygen of 20 ml/m²·day·atm or smaller under the environment of 23° C. and 60% RH. It is preferable that at least two layers which are a sealant layer and the gas barrier layer are laminated in this order from the standpoint of the use as the cap part. It is sufficient that the two layers described above are laminated in the above order in the cap part. An intermediate layer may be laminated between the two layers. A layer of PET and a layer comprising another resin may be laminated on the outside of the laminate of the two layers.

The PP layer constituting the multilayer container and the cap part used in the present invention is a layer comprising PP as the main component. The PP layer plays the role of separating the gas barrier layer from the food and also plays the role of the sealant for adhesion with a top film after the food is placed in the container. As PP, a conventional material can be used. Examples of PP include homopolypropylene, propylene-ethylene random copolymers and propylene-ethylene block copolymers as distinguished based on the chemical structure. The PP layer may comprise coloring pigments such as titanium oxide to improve the appearance and may further comprise additives such as antioxidants to prevent oxidation of PP, matting agents, weather stabilizers, ultraviolet light absorbents, nucleating agents, plasticizers, flame retardants and antistatic agents. Where necessary, the PP layer may comprise thermoplastic resins such as polyethylene and ethylene-α-olefin copolymers to improve the physical properties of PP.

The adhesive layer (B) constituting the multilayer container used in the present invention plays the role of adhering the PP layer and the gas barrier layer with each other with a sufficient strength. Examples of the adhesive thermoplastic resin used for the adhesive layer include polyolefins modified with an acid which are obtained by modifying a olefin-based resin with an unsaturated carboxylic acid such as acrylic acid, methacrylic acid, maleic acid and maleic anhydride. Among the above resins, adhesive thermoplastic resins obtained by modifying resins containing polypropylene as the main component are preferable from the standpoint of adhesion with PP.

The gas barrier layer (C) constituting the multilayer container used in the present invention comprises a polyamide resin which is obtained by polycondensation of a diamine component comprising 70% by mole or more of meta-xylylenediamine and a dicarboxylic acid component comprising 80 to 97% by mole of an α,ω-linear aliphatic dicarboxylic acid and 3 to 20% by mole of an aromatic dicarboxylic acid and has substantially no hydroxyl group.

The gas barrier layer (C) has a coefficient of permeation of oxygen of 1.0 ml mm/m²·day·atm or smaller under the environment of 23° C. and 60% RH and plays the role such that invasion of oxygen from the outside of the container is shut off and degradation of the food by oxidation is prevented.

A smaller coefficient of permeation of oxygen is preferable. It is preferable that the coefficient of permeation of oxygen is 0.5 ml mm/m²·day·atm or smaller and, more preferably, 0.1 ml mm/m²·day·atm or smaller.

As for the diamine component constituting the polyamide resin, it is necessary that meta-xylylenediamine is contained in an amount of 70% by mole or more. It is preferable that meta-xylylenediamine is contained in an amount of 80% by mole or more and more preferably 90% by mole or more. When the amount of meta-xylylenediamine in the diamine component is 70% by mole or more, the polyamide resin obtained by using the diamine component can exhibit excellent gas barrier property. Examples of the diamine other than meta-xylylenediamine which can be used include para-xylylenediamine, 1,3-bis(aminomethyl)cyclohexane, 1,4-bis(aminomethyl)cyclohexane, tetramethylenediamine, hexa-methylenediamine, nonamethylenediamine and 2-methyl-1,5-pentane-diamine. However, the diamine is not limited to the compounds described above.

The dicarboxylic acid component constituting the polyamide resin is a component comprising 80 to 97% by mole of an α,ω-linear aliphatic dicarboxylic acid and 3 to 20% by mole of an aromatic dicarboxylic acid, preferably 85 to 96% by mole of an α,ω-linear aliphatic dicarboxylic acid and 4 to 15% by mole of an aromatic dicarboxylic acid, and more preferably 90 to 95% by mole of an α,ω-linear aliphatic dicarboxylic acid and 5 to 10% by mole of an aromatic dicarboxylic acid. As the α,ω-linear aliphatic dicarboxylic acid, at least one compound selected from α,ω-linear aliphatic dicarboxylic acids having 4 to 20 carbon atoms is used, and adipic acid is preferable. As the aromatic dicarboxylic acid, at least one compound selected from isophthalic acid and 2,6-naphthalenedicarboxylic acid is used, and isophthalic acid is preferable. When the amount of the α,ω-linear aliphatic dicarboxylic acid is 80% by mole or more in the dicarboxylic acid component, the decrease in the gas barrier property and the excessive decrease in the crystallinity can be prevented. When the amount of the aromatic dicarboxylic acid is 3% by mole or more in the dicarboxylic acid component, the amorphous property of the polyamide resin increases to decrease the rate of crystallization, and the property for heat molding during molding of the container is improved. However, when the amount of the aromatic dicarboxylic acid exceeds 20% by mole, the preparation of the multilayer sheet becomes difficult since the polymerization cannot be achieved out until the melt viscosity necessary for the molding of the multilayer sheet is obtained. Moreover, the multilayer container of PP using the polyamide resin as the gas barrier layer is whitened after sterilization by heating since the polyamide resin exhibits almost no crystallinity. Therefore, the amount of the aromatic dicarboxylic acid outside the above range is not preferable.

The polyamide resin described above is obtained by conducting the melt polycondensation, followed by conducting the solid phase polymerization. As the process for the melt polycondensation, for example, a nylon salt comprising the diamine component and the dicarboxylic acid component is polymerized in the melted condition by elevating the temperature under an added pressure in the presence of water while water added to the system and water formed by the condensation are removed. Alternatively, the polyamide can be produced by directly adding the diamine component to the dicarboxylic acid component in the melted condition to conduct the polycondensation. In this case, the diamine component and the dicarboxylic acid component are added continuously so that the reaction system is kept in the uniform liquid condition and, during the addition, the polycondensation is allowed to proceed while the temperature of the reaction system is elevated in a manner such that the temperature of the reaction system is not lowered to a temperature below the melting point of the formed oligoamides and polyamide resin. The polymer obtained in accordance with the melt polycondensation is separated and, then, the solid phase polymerization is conducted. As the heating apparatus used for the solid phase polymerization, batch heating apparatuses are preferable to continuous heating apparatuses since the batch heating apparatuses can be tightly sealed, and the contact of the polyamide resin with oxygen can be highly prevented. Heating apparatuses of the rotating drum type such as tumble driers, conical driers and rotary driers and heating apparatuses of the cone type having rotating blades at the inside which is called the Natuta Mixer are advantageously used. However, the heating apparatus is not limited to those described above.

The solid phase polymerization of the polyamide resin is conducted in the following three steps: the first step in which the degree of crystallization of the polyamide resin is increased so that aggregation of pellets of the polyamide resin by melting and adhesion of the pellets of the polyamide resin to the inner wall of the apparatus can be prevented; the second step in which the molecular weight of the polyamide resin is increased; and the third step in which the obtained polyamide resin is cooled after the solid phase polymerization is allowed to proceed until the desired molecular weight is obtained. In the first step, it is preferable that the polymerization is conducted at the glass transition temperature of the polyamide resin or lower. In the second step, it is preferable that the polymerization is conducted at a temperature lower than the melting point of the polyamide resin under a reduced pressure. However, the condition of the solid phase polymerization in the present invention is not limited to the conditions described above.

The polyamide resin described above may comprise a phosphorus compound so that stability of the operation during the melt molding is improved or coloring of the polyamide resin is prevented. As the phosphorus compound, phosphorus compounds having alkali metals or alkaline earth metals are preferable. Examples of the phosphorus compound include phosphates, hypophosphites and phosphites of sodium, magnesium and calcium. Hypophosphites of alkali metals and alkaline earth metals are more preferable due to the excellent effect of preventing coloring of the polyamide resin. The polyamide described above may further comprise additives such as lubricants, matting agents, heat stabilizers, weather stabilizers, ultraviolet light absorbents, nucleating agents, plasticizers, flame retardants, antistatic agents, agents preventing coloring and agents preventing gelation as long as the effect of the present invention is not adversely affected. The polyamide resin described above may comprise various materials which are not limited to the additives described above.

The polyamide resin described above may be used as a mixture with other thermoplastic resins as long as the characteristics of the present invention is not adversely affected. Examples of the other thermoplastic resin include various types of polyolefins such as polyethylene and polypropylene; various types of polyesters such as PET and polyethylene-2,6-naphthalenedicarboxylate; various types of polyamides such as polyamide 6, polyamide 6,6 and amorphous polyamide, and various types of other thermoplastic resins such as thermoplastic elastomers, polystyrene and ionomers.

The polyamide used in the present invention is occasionally whitened by crystallization due to absorption of water, and the appearance of the container is adversely affected. To prevent such undesirable phenomenon, it is preferable in the present invention that a mixture obtained by adding a specific compound such as a metal salt of a fatty acid, a diamide compound or a diester compound as the agent for preventing whitening to the polyamide resin is used for an intermediate layer of the container. By using the above mixture for the intermediate layer, the whitening of the polyamide resin can be prevented even when the multilayer container having contents is stored for long period of time.

The metal salt of a fatty acid used in the present invention is a metal salt of a fatty acid having 18 to 50 carbon atom and preferably having 18 to 34 carbon atoms. When the number of carbon atom is 18 or greater, whitening can be prevented when the polyamide resin absorbs water. When the number of carbon atom is 50 or smaller, uniform dispersion into the resin composition can be achieved excellently. Although the fatty acid may have side chains and double bonds, linear saturated fatty acids such as stearic acid (18 carbon atoms), eicosic acid (20 carbon atoms), behenic acid (22 carbon atoms), montanoic acid (28 carbon atoms) and triacontanoic acid (30 carbon atoms) are preferable. The metal forming the salt with the fatty acid is not particularly limited. Examples of the metal include sodium, potassium, lithium, calcium, barium, magnesium, strontium, aluminum and zinc. Among these metals, sodium, potassium, lithium, calcium, aluminum and zinc are preferable.

The metal salt of a fatty acid used in the present invention may be selected from the above salts of fatty acids singly or in combination of two or more. In the present invention, the shape of the metal salt of a fatty acid is not particularly limited. It is preferable that the particle diameter of the metal salt of a fatty acid is 0.2 mm or smaller since uniform dispersion into the resin composition can be more easily achieved when the diameter is smaller.

In the present invention, the amount of the metal salt of a fatty acid is 0.005 to 1.0 part by mass, preferably 0.05 to 0.5 parts by mass and more preferably 0.12 to 0.5 parts by mass per 100 parts by mass of the polyamide resin. When the amount of the metal salt of a fatty acid is less than 0.005 parts by mass, the practical effect of preventing whitening cannot be obtained. When the amount exceeds 1.0 part by mass, the polyamide becomes turbid and white due to the effect of the metal salt of a fatty acid. Therefore, an amount outside the above range is not preferable.

The diamide compound used in the present invention is a diamide compound obtained from a fatty acid having 8 to 30 carbon atoms and a diamine having 2 to 10 carbon atoms. When the number of carbon atom in the fatty acid is 8 or more and the number of carbon atom in the diamine is 2 or more, it is expected that the effect of preventing whitening is exhibited. When the number of carbon atom in the fatty acid is 30 or less and the number of carbon atoms in the diamine is 10 or less, uniform dispersion into the resin composition can be achieved excellently.

As the fatty acid used for the diamide compound, linear saturated fatty acids are preferable although the fatty acid may have side chains and double bonds. Examples of the fatty acid include stearic acid (18 carbon atoms), eicosic acid (20 carbon atoms), behenic acid (22 carbon atoms), montanoic acid (28 carbon atoms) and triacontanoic acid (30 carbon atoms). Among these fatty acids, montanoic acid is preferable. Example of the diamine used for the diamide compound include ethylenediamine, butylenediamine, hexanediamine, xylylenediamine and bis(aminomethyl)cyclohexane. Among these diamines, ethylenediamine is preferable. The diamide compound obtained by the combination of the above compounds is used in the present invention. The diamide compound may be used singly or in combination of two or more.

The diester compound used in the present invention is a diester compound obtained from a fatty acid having 8 to 30 carbon atoms and a diol having 2 to 10 carbon atoms. When the number of carbon atom in the fatty acid is 8 or more and the number of carbon atom in the diol is 2 or more, it is expected that the effect of preventing whitening is exhibited. When the number of carbon atom in the fatty acid is 30 or less and the number of carbon atoms in the diol is 10 or less, uniform dispersion into the resin composition can be achieved excellently.

Examples of the fatty acid used for the diester compound include stearic acid (18 carbon atoms), eicosic acid (20 carbon atoms), behenic acid (22 carbon atoms), montanoic acid (28 carbon atoms) and triacontanoic acid (30 carbon atoms). Among these fatty acids, montanoic acid is preferable. Examples of the diol used for the diester compound include ethylene glycol, propanediol, butanediol, hexanediol, xylylene glycol and cyclohexanedimethanol. Among these diols, ethylene glycol and 1,3-butanediol are preferable. The diester compound obtained by the combination of the above compounds is used in the present invention. The diester compound may be used singly or in combination of two or more.

The diamide compound and the diester compound used in the present invention may be used singly or in combination.

In the present invention, the amount of the diamide compound and/or the diester compound is 0.005 to 1.0 part by mass, preferably 0.05 to 0.5 parts by mass and more preferably 0.12 to 0.5 parts by mass per 100 parts by mass of the polyamide. When the amount of the diamide compound and/or the diester compound is less than 0.005 parts by mass, the practical effect of preventing whitening cannot be obtained. When the amount exceeds 1.0 part by mass, the polyamide becomes turbid and white due to the effect of the diamide compound and/or the diester compound. Therefore, an amount outside the above range is not preferable.

As the process for adding the above agent for preventing whitening to the polyamide resin, a conventional process for mixing can be used. For example, pellets of the polyamide resin and the agent for preventing whitening may be placed into a rotating hollow vessel, and the obtained mixture may be used. As another process, after a composition containing the agent for preventing whitening in a great concentration is prepared, the composition may be diluted to a prescribed concentration with pellets of the polyamide containing no agent for preventing whitening, and the obtained mixture may be melt-mixed. The obtained product of the melt-mixing may be formed into a molded product by injection molding or the like process.

In the present invention, the polyamide resin obtained above may be mixed with at least one metal atom selected from transition metal atoms of Groups 8 to 10 of the Periodic Table, such as iron, cobalt and nickel, manganese, copper and zinc so that a more excellent barrier property to oxygen is provided. The gas barrier layer comprising the above metal atom becomes an oxygen-absorbing resin layer having the function of absorbing oxygen.

The oxygen-absorbing resin layer may be obtained by mixing the metal atom described above with a resin other than the polyamide resin. The function of absorbing oxygen is provided to the gas barrier layer by laminating the obtained oxygen-absorbing resin layer. In this case, as the gas barrier layer, the gas barrier layer having the function of absorbing oxygen described above may be used.

In the present invention, it is preferable that a compound comprising a metal atom (referred to as a metal catalyst compound, hereinafter) is used for adding the metal atom into the polyamide resin. The metal catalyst compound is used in the form of a salt of an inorganic acid, a salt of an organic acid or a salt of complex compound of the lower-valence metal atom described above. Example of the salt of an inorganic acid include halides such as chlorides and bromides, sulfates, nitrates, phosphates and silicates. Examples of the salt of an organic acid include carboxylates, sulfonates and phosphonates. Complex compounds of transition metals such as β-diketones and β-diketoesters may be used. In the present invention, it is preferable that carboxylates, halides and complexes with acetylacetone having the above metal atom are used due to the excellent function of absorbing oxygen. In the present invention, at least one compound selected from the above metal catalyst compounds can be added to the polyamide resin. Metal catalyst compounds having cobalt metal atom are preferable due to the excellent function of absorbing oxygen.

In the present invention, the concentration of the metal atom which can be added to the polyamide resin is not particularly limited. It is preferable that the metal atom is added in an amount in the range of 0.01 to 0.10 part by mass and more preferably 0.02 to 0.08 parts by mass per 100 parts by mass of the polyamide resin. When the amount of the added metal atom is less than 0.01 part by mass, the function of absorbing oxygen is not sufficiently exhibited, and the effect of improving the barrier property to oxygen of the multilayer container is small. When the amount of the added metal atom exceeds 0.10 part by mass, the effect of improving the barrier property to oxygen of the multilayer container is not increased, and the amount is economically disadvantageous.

As the process for adding the metal catalyst compound to the polyamide resin, a process in which the polyamide resin and the metal catalyst compound are melt-mixed by an extruder or the like, a process in which, after the metal catalyst compound is mixed with a solvent to form a solution or a slurry, the resultant solution or the slurry is mixed with the polyamide resin and, then, the solvent is removed so that the metal catalyst compound is attached to the polyamide resin, and a process in which an apparatus for adding the metal catalyst is attached at the apparatus for producing the multilayer container, and the metal catalyst compound is added to the polyamide resin using the attached apparatus, can be used. Among these processes, the process in which the polyamide resin and the metal catalyst compound are melt-mixed by an extruder or the like is preferable since the metal catalyst compound can be easily mixed into the polyamide resin.

In the present invention, a product obtained by adding a lamellar silica to the polyamide resin may be used as the gas barrier layer. When this product is used, the barrier property of the multilayer container can be improved not only to oxygen but also to other gases such as carbon dioxide.

The lamellar silica is a lamellar silica of the two octahedron type or a lamellar silica of the three octahedron type having a charge density of 0.25 to 0.6. Examples of the lamellar silicate of the two octahedron type include montmorillonite and beidellite. Examples of the lamellar silicate of the three octahedron type include hectorite and saponite. Among these silicates, montmorillonite is preferable.

As the lamellar silica, a lamellar silica which is obtained by bringing an organic swelling agent such as a macromolecular compound or an organic compound into contact with the lamellar silica in advance so that the distance between layers is increased, is preferable. As the organic swelling agent, quaternary ammonium salts are preferable, and quaternary ammonium salts having at least one alkyl or alkenyl group having 12 or more carbon atoms are more preferable.

Examples of the organic swelling agent include trimethylalkylammonium salts such as trimethyldodecylammonium salts, trimethyltetradecylammonium salts, trimethylhexadecylammonium salts, trimethyloctadecylammonium salts and trimethyleicosylammonium salts; trimethylalkenylammonium salts such as trimethyloctadecenylammonium salts and trimethyloctadecadienylammonium salts; triethylalkylammonium salts such as triethyldodecylammonium salts, triethyltetradecylammonium salts, triethylhexadecylammonium salts and triethyloctadecylammonium salts; tributylalkylammonium salts such as tributyldodecylammonium salts, tributyltetradecylammonium salts, tributylhexadecylammonium salts and tributyloctadecylammonium salts; dimethyldialkylammonium salts such as dimethyldidodecylammonium salts, dimethylditetradecylammonium salts, dimethyldihexadecylammonium salts, dimethyldioctadecylammonium salts and dimethylditallowammonium salts; dimethyldialkenylammonium salts such as dimethyldioctadecenylammonium salts and dimethyldioctadecadienylammonium salts; diethyldialkylammonium salts such as diethyldidodecylammonium salts, diethylditetradecylammonium salts, diethyldihexadecylammonium salts and diethyldioctadecylammonium salts; dibutyldialkylammonium salts such as dibutyldidodecylammonium salts, dibutylditetradecylammonium salts, dibutyldihexadecylammonium salts and dibutyldioctadecylammonium salts; methylbenzyldialkylammonium salts such as methylbenzyldihexadecylammonium salts; dibenzyldialkylammonium salts such as dibenzyldihexadecylammonium salts; trialkylmethylammonium salts such as tridodecylmethylammonium salts, tritetradecylmethylammonium salts and trioctadecylmethylammonium salts; trialkylethylammonium salts such as tridodecylethylammonium salts; trialkylbutylammonium salts such as tridodecylbutylammonium salts; and ω-aminoacids such as 4-amino-n-butyric acid, 6-amino-n-caproic acid, 8-aminocaprylic acid, 10-aminodecanoic acid, 12-aminododecanoic acid, 14-aminotetradecanoic acid, 16-aminohexadecanoic acid and 18-aminooctadecanoic acid. Ammonium salts having hydroxyl group and/or ether group can be used as the organic swelling agent. Among the above ammonium salts, in particular, quaternary ammonium salts having at least one alkylene glycol residue group can be used as the organic swelling agent. Examples of the quaternary ammonium salts having at least one alkylene glycol residue group include methyldialkyl(PAG)ammonium salts, ethyldialkyl(PAG)ammonium salts, butyldialkyl(PAG)ammonium salts, dimethylbis(PAG)ammonium salts, diethylbis(PAG)ammonium salts, dibutylbis(PAG)ammonium salts, methylalkylbis(PAG)ammonium salts, ethylalkylbis(PAG)ammonium salts, butylalkylbis(PAG)ammonium salts, methyltri(PAG)ammonium salts, ethyltri(PAG)ammonium salts, butyltri(PAG)ammonium salts and tetra(PAG)ammonium salts, wherein “alkyl” means an alkyl group having 12 or more carbon atoms such as dodecyl group, tetradecyl group, hexadecyl group, octadecyl group and eicosyl group, and “PAG” means a polyalkylene glycol residue group and, preferably, a polyalkylene glycol residue group having 20 or less carbon atoms such as polyethylene glycol residue group or polypropylene glycol residue group. Among the above organic swelling agents, trimethyldodecylammonium salts, trimethyltetradecylammonium salts, trimethylhexadecylammonium salts, trimethyloctadecylammonium salts, dimethyldidodecylammonium salts, dimethylditetradecylammonium salts, dimethyhldihexadecylammonium salts, dimethyldioctadecylammonium salts and dimethylditallowammonium salts are preferable. The organic swelling agent may be used singly or as a mixture of two or more.

In the present invention, the lamellar silica treated with the organic swelling agent is used in an amount of 0.5 to 8 parts by mass, preferably 1 to 6 parts by mass and more preferably 2 to 5 parts by mass per 100 parts by mass of the polyamide resin. When the amount of the lamellar silica is less than 0.5 parts by mass, the effect of improving the gas barrier property is small. When the amount of the lamellar silica exceeds 8 parts by mass, transparency of the multilayer container is adversely affected since the intermediate layer becomes turbid. Therefore, an amount outside the above range is not preferable.

In the polyamide resin of the present invention, it is preferable that the lamellar silica is dispersed uniformly without local aggregation. The “uniform dispersion” means that the lamellar silica forms separate layers of a flat plate shape in the polyamide resin and 50% or more of the layers have a distance between the layers of 5 nm or greater. The “distance between the layers” means the distance between centers of gravity of the layers of the flat plate shape. As the distance is increased, the condition of dispersion becomes better, the appearance such as transparency becomes better, and the barrier property to a gas such as oxygen, carbon dioxide and the like are improved.

The process for mixing the polyamide resin and the lamellar silica is not particularly limited. In the present invention, the melt-mixing process is preferable. For example, a conventional process such as the process in which the lamellar silica is added and stirred while the resin is prepared by polycondensation, and the process in which the polyamide resin and the lamellar silica are melt-mixed using a conventional extruder such as a single screw extruder or a twin screw extruder, can be used. In the present invention, the process of melt-mixing using a twin screw extruder is preferable among these processes.

As described above, the agent for preventing whitening, the metal catalyst compound providing the function of absorbing oxygen and the lamellar silica exhibiting the effect of improving the gas barrier property can be added to the polyamide resin constituting the gas barrier layer in the multilayer container used in the present invention. The above additives may be used in combination.

In the process for producing the multilayer container used in the present invention, for example, an apparatus for producing a multilayer sheet equipped with three extruders, feed blocks, T-dies, a cooling roll and a winding machine is used. PP is extruded by the first extruder, the adhesive resin is extruded by the second extruder, and the resin having the gas barrier property is extruded by the third extruder. In this manner, a multilayer sheet made of the three materials and having a structure having five layers of a PP layer/a layer of the adhesive resin/a gas barrier layer/a layer of the adhesive resin/a PP layer is produced via the feed block. After the produced sheet is softened by heating, the sheet is tightly attached to a mold by pressing using a vacuum, using an added pressure or in accordance with the heat forming process using a combination of a vacuum and an added pressure so that the sheet is molded into the shape of the container, and the container is obtained after trimming. The process for producing the multilayer sheet and the process for molding the sheet to obtain the container are not limited to the processes described above, and other conventional processes can be used.

It is preferable that the thickness of the gas barrier layer in the multilayer container used in the present invention is set in the range of 2 to 20%, preferably in the range of 3 to 18% and more preferably in the range of 5 to 15% as the ratio of the thickness of the gas barrier layer to the thickness of the entire multilayer container. When the thickness of the gas barrier layer is smaller than 2%, there is the possibility that the gas barrier property is not sufficiently exhibited at some portions of the container since portions of the container such as corner portions occasionally have a small thickness depending on the shape of the container, and degradation, color change and discoloration of food having the retort treatment take place. When the thickness exceeds 20%, the cost of the container increases to cause economic disadvantage although the gas barrier property is improved, and appearance of the multilayer sheet may deteriorate occasionally due to the loss of the balance of the flow rates relative to the adjacent layers.

To the multilayer container used in the present invention, layers of various thermoplastic resins other than the PP layer, the layer of the adhesive resin and the gas barrier layer may be laminated, where necessary. For example, a product obtained by pulverizing the scrap material formed by trimming in the production of the multilayer sheet and the multilayer container is used singly or as a mixture with PP or other thermoplastic resins to form a layer of a recycled resin, which is laminated as an intermediate layer between the PP layer and the layer of the adhesive layer. A layer of a thermoplastic resin comprising polycarbonate or various types of easy-peel resins may be laminated to the outer side of the PP layer so that the multilayer container has a specific character. Layers of various other thermoplastic resins which are not limited to the thermoplastic resins described above can be laminated in accordance with the object.

The shape of the multilayer container used in the present invention is not particularly limited and may be a shape of a cup, a shape of a tray, a shape of a bottle or a shape of a tube. A flange portion or a handle portion may be formed in the multilayer container. For example, it is possible that a flange portion is formed in the multilayer container, and the formed flange portion may be subjected to a specific treatment so that the easy-peel function is provided.

As the cap part used in the present invention, a cap part having a gas barrier layer having a permeability of oxygen of 20 ml/m²·day·atm or smaller under an environment of 23° C. and 60% RH is used.

The smaller the permeability of oxygen, the better. It is preferable that the permeability of oxygen is 10 ml/m²·day·atm or smaller, more preferably 5 ml/m²·day·atm or smaller and most preferably 0.5 ml/m²·day·atm or smaller.

As the gas barrier layer, a thin film of a metal such as aluminum, a thin film obtained by inorganic vapor deposition of silica, aluminum or alumina on PET or Nylon 6 (Ny6), or a multilayer or blended film comprising an ethylene-vinyl alcohol copolymer and N-MXD6 or a combination of Ny6 and MXD6 can be used. A gas barrier layer having a multilayer structure in which the above material is laminated to other materials may also be used. It is preferable that a film having a laminated aluminum foil, a laminate film having vapor deposited silica or a laminate film having vapor deposited alumina is used. The cap part plays the role of shutting off oxygen permeating through the cap part and preventing degradation of food by oxidation during sterilization of the food by heating and storage of the food sterilized by heating.

The permeability of oxygen can be adjusted at the prescribed value or smaller by suitably selecting the type and the thickness of the layer used for the cap part.

Examples of the construction of the layer of the cap part used in the present invention include PET/a thin film of a metal (a gas barrier layer)/CPP (a non-stretched polypropylene film), PET/a thin film of a metal/Ny6/CPP, PET having a vapor deposited inorganic compound (a gas barrier layer)/CPP, PET having a vapor deposited inorganic compound/Ny6/CPP, wherein the component layers are attached from the outermost layer to the innermost layer in the order described above. However, the construction of the layer of the cap part is not limited to the above construction. It is preferable that the number of pin holes and cracks after the sterilization by heating is small, and it is more preferable that pin holes and cracks are absent.

In the cap part used in the present invention, a resin layer absorbing oxygen obtained by mixing a compound of a metal such as cobalt with N-MXD6 by a twin screw extruder or by mixing iron powder with polyethylene by a twin screw extruder may be formed similarly to the container used in the present invention.

By sealing food sterilized by heating in the container for preservation of the present invention which comprises the multilayer container of PP and the cap part, permeation of gases through the container for preservation can be prevented. As the result, the method for preserving food by which color change and discoloration of the food sterilized by heating can be prevented for a long period of time can be provided.

When the food sterilized by heating is taken out of the container for preservation, the multilayer container and the cap part can be easily separated.

The sterilization by heating in the present invention may be conducted by the treatment with steam, with hot water stored in a tank or with shower. The temperature of the sterilization is in the range of 80 to 140° C., and the time of the sterilization is 10 to 120 minutes.

Examples of the food sterilized by heating which can be preserved in accordance with the method of the present invention include processed marine foods, processed livestock foods, cooked rice and liquid foods. Specific examples of the food include processed marine foods such as boiled products, oiled products, smoked and oiled products, seasoned products, broiled products and products processed with tomato of tuna, bonito, salmon, trout, mackerel, sardine, saury, herring, eel, crab, scallop, ark shell, clam, oyster, ivory shellfish, hokki shellfish, top shell, squid, seaweed, brown algae (hijiki seaweed), agar, kuki-wakame and kombu; processed livestock foods such as salted products, oiled products, boiled products and seasoned products such as corned beef, beef, sausage, ham, pork, chicken, egg and quail egg; cooked rice such as white cooked rice, red cooked rice, boiled rice mixed with fish and vegetables, kayu and zosui; sauces such as curry, stew, hashed beef, pasta sauce, cooking sauce; liquid foods such as western soup, Chinese soup and Japanese soup; and processed products of agricultural products such as orange, pine apple, cherry, apricot, chestnut, grape, tomato, corn, bamboo shoots and mushroom. Examples of the food sterilized by heating which can be preserved in accordance with the method of the present invention also include other foods which must be sterilized by heating and pet foods for dogs and cats. The method of the present invention is suitable for preservation of tuna, bonito and white cooked rice which are sterilized at a high temperature of 100° C. or higher and tend to be affected by the presence of oxygen.

### EXAMPLES

The present invention will be described more specifically with reference to examples in the following. However, the present invention is not limited to the examples. Various evaluations in the Examples and Comparative Examples were conducted in accordance with the following methods.

### (1) Color Change and Discoloration of Food After the Retort Treatment

After a container packed with food was subjected to the retort treatment under the following condition, the color tone of the food after the storage was examined by visual observation. When no color change or discoloration was found, the result was evaluated as good. When some color change and discoloration were found, the result was evaluated as fair. When apparent color change and discoloration were found, the result was evaluated as poor.

The condition of the retort treatment
apparatus for the treatment: an apparatus manufactured by TOMY SEIKO Co., Ltd.; SR-240
temperature of the treatment: 121° C.
time of the treatment: 30 minutes (times for heating and cooling not included in this time.)

### (2) Gas Barrier Property

The gas barrier property was evaluated in accordance with the method of ASTM D3985.

Using OX-TRAN 10/50A manufactured by MODERN CONTROLS Company, the coefficient of permeation of oxygen (ml·mm/m²·day·atom) through the gas barrier layer of a multilayer container and the permeability of oxygen (ml /m²·day·atom) through the gas barrier layer of a cap part were measured under the environment of 23° C. and 60% RH.

Using OX-TRAN 2/61 manufactured by MODERN CONTROLS Company, the permeability (ml/0.21 atm·day·package) of oxygen through a multilayer container after the retort treatment was measured under the atmosphere such that the temperature was 23° C., the relative humidity at the inside of the container was 100%, and the relative humidity at the outside was 50%. The accumulated amount of permeation of oxygen (ml/0.21 atm·package) permeated into the container was calculated from the obtained permeability.

### Example 1

An apparatus for producing a multilayer sheet equipped with three extruders, feed blocks, T-dies, a cooling roll and a winding machine was used. PP (manufactured by Japan Polypropylene Corp.; the trade name: NOVATEC PP; the grade name: FY6; the melt index: 2.3) was extruded by the first extruder at 240° C. An adhesive resin (manufactured by MITSUI CHEMICALS, INC.; the trade name: ADMER; the grade name: QB550) was extruded by the second extruder at 230° C. Polyamide resin 1 (a polyamide resin obtained by polycondensation of a diamine component comprising meta-xylylenediamine and a dicarboxylic acid component comprising 94% by mole of adipic acid and 6% by mole of isophthalic acid) was extruded by the third extruder at 250° C. A multilayer sheet made of the three materials and having a structure having five layers of a PP layer/a layer of the adhesive resin/a gas barrier layer/a layer of the adhesive resin/a PP layer was produced via the feed blocks. The thicknesses of the layers were adjusted at 425/25/80/25/425 (μm). The heat molding was conducted by a molding machine using a reduced pressure and an added pressure and equipped with a plug assist when the temperature at the surface of the sheet reached 170° C., and a container having a cup shape having a diameter of the opening of 62 mm, a diameter of the bottom of 52 mm, a depth of 28 mm, a surface area of 73 cm² and a volume of 70 ml was obtained. The coefficient of permeation of oxygen through the gas barrier layer of the obtained container was 0.07 ml·mm/m²·day·atom.

Then, the container was fully packed with chopped carrot and water. The opening was heat sealed with a cap part made of a film of CPP/an aluminum foil/PET=50/9/12 (μm) (the permeability of oxygen through the gas barrier layer (aluminum foil) was at the limit of detection (0.1 ml /m²·day·atom) or smaller). The sealed container was subjected to the retort treatment at 121° C. for 30 minutes using an autoclave. The container was stored at 23° C. under 50% RH for one month, and the change of the color tone of carrot was examined by observation. The result is shown in Table 1.

Separately, the retort treatment was conducted as described above except that the container was fully packed with water alone. Then, after 60 ml of water was removed through a hole formed in the film of the cap part, an inlet tube for a gas and an outlet tube for a gas were inserted, and the portions of the insertion were tightly sealed with an epoxy-based adhesive. A stream of nitrogen gas was introduced through the inlet tube for a gas at a flow rate of 10 ml/min. The permeability of oxygen was measured using an apparatus for measuring the permeability of oxygen gas, and the accumulated amount of permeation of oxygen was calculated. The result is shown in Table 2.

### Example 2

The same procedures as those conducted in Example 1 were conducted except that the container was fully packed with oiled tuna. After the retort treatment, the color tone after the storage was examined by observation. The result is shown in Table 1.

### Example 3

The same procedures as those conducted in Example 1 were conducted except that the container was fully packed with boiled bonito. After the retort treatment, the color tone after the storage was examined by observation. The result is shown in Table 1.

### Example 4

The same procedures as those conducted in Example 1 were conducted except that a film having an oxygen-absorbing resin layer (manufactured by Mitsubishi Gas Chemical Company, Inc.; the trade name: AGELESS OMAC; the permeability of oxygen through the gas barrier layer (the film) was at the limit of detection (0.1 ml /m²·day·atom) or smaller) was used for the cap part. After the retort treatment, the color tone after the storage was examined by observation. The result is shown in Table 1.

### Example 5

The same procedures as those conducted in Example 2 were conducted except that a film having an oxygen-absorbing resin layer (manufactured by Mitsubishi Gas Chemical Company, Inc.; the trade name: AGELESS OMAC; the permeability of oxygen through the gas barrier layer (the film) was at the limit of detection (0.1 ml /m²·day·atom) or smaller) was used for the cap part. After the retort treatment, the color tone after the storage was examined by observation. The result is shown in Table 1.

### Example 6

The same procedures as those conducted in Example 3 were conducted except that a film having an oxygen-absorbing resin layer (manufactured by Mitsubishi Gas Chemical Company, Inc.; the trade name: AGELESS OMAC; the permeability of oxygen through the gas barrier layer (the film) was at the limit of detection (0.1 ml /m²·day·atom) or smaller) was used for the cap part. After the retort treatment, the color tone after the storage was examined by observation. The result is shown in Table 1.

### Example 7

The same procedures as those conducted in Example 2 were conducted except that polyamide resin 2 (a polyamide resin obtained by polycondensation of a diamine component comprising meta-xylylene-diamine and a dicarboxylic acid component comprising 85% by mole of adipic acid and 15% by mole of isophthalic acid) was used. After the retort treatment, the color tone after the storage was examined by observation. The result is shown in Table 1. The gas barrier layer of the container had a coefficient of permeation of oxygen of 0.07 ml·mm/m²·day·atom.

Separately, the retort treatment was conducted as described above except that the container was fully packed with water alone. Then, after 60 ml of water was removed through a hole formed in the film of the cap part, an inlet tube for a gas and an outlet tube for a gas were inserted, and the portions of the insertion were tightly sealed with an epoxy-based adhesive. A stream of nitrogen gas was introduced through the inlet tube for a gas at a flow rate of 10 ml/min. The permeability of oxygen was measured using an apparatus for measuring the permeability of oxygen gas, and the accumulated amount of permeation of oxygen was calculated. The result is shown in Table 2.

### Example 8

The same procedures as those conducted in Example 3 were conducted except that polyamide resin 2 was used as the polyamide resin. After the retort treatment, the color tone after the storage was examined by observation. The result is shown in Table 1.

### Comparative Example 1

An apparatus for producing a multilayer sheet equipped with three extruders, feed blocks, T-dies, a cooling roll and a winding machine was used. PP (manufactured by Japan Polypropylene Corp.; the trade name: NOVATEC PP; the grade name: FY6; the melt index: 2.3) was extruded by the first extruder at 220° C. An adhesive resin (manufactured by MITSUI CHEMICALS, INC.; the trade name: ADMER; the grade name: QF551) was extruded by the second extruder at 210° C. EVOH (manufactured by KURARAY CO., LTD.; the trade name: EVAL; the grade: F101B; the melting point: 175° C.; forming a gas barrier layer) was extruded by the third extruder at 220° C. A multilayer sheet made of the three materials and having a structure having five layers of a PP layer/a layer of the adhesive resin/a gas barrier layer/a layer of the adhesive resin/a PP layer was produced via the feed blocks. The thicknesses of the layers were adjusted at 425/25/80/25/425 (μm).

The heat molding was conducted by a molding machine using a reduced pressure and an added pressure and equipped with a plug assist when the temperature at the surface of the sheet reached 180° C., and a container having a cup shape having a diameter of the opening of 62 mm, a diameter of the bottom of 52 mm, a depth of 28 mm, a surface area of 73 cm² and a volume of 70 ml was obtained. The coefficient of permeation of oxygen through the gas barrier layer of the obtained container was 0.01 ml mm/m²·day·atom.

Then, the container was fully packed with chopped carrot and water. The opening was heat sealed with a cap part made of a film of CPP/an aluminum foil/PET=50/9/12 (μm) (the permeability of oxygen through the gas barrier layer (aluminum foil) was at the limit of detection (0.1 ml /m²·day·atom) or smaller). The sealed container was subjected to the retort treatment at 121° C. for 30 minutes using an autoclave. The container was stored at 23° C. under 50% RH for one month, and the change of the color tone was examined by observation. The result is shown in Table 1.

Separately, the retort treatment was conducted as described above except that the container was fully packed with water alone. Then, after 60 ml of water was removed through a hole formed in the film of the cap part, an inlet tube for a gas and an outlet tube for a gas were inserted, and the portions of the insertion were tightly sealed with an epoxy-based adhesive. A stream of nitrogen gas was introduced through the inlet tube for a gas at a flow rate of 10 ml/min. The permeability of oxygen was measured using an apparatus for measuring the permeability of oxygen gas, and the accumulated amount of permeation of oxygen was calculated. The result is shown in Table 2.

### Comparative Example 2

The same procedures as those conducted in Comparative Example 1 were conducted except that the container was fully packed with oiled tuna. After the retort treatment, the color tone after the storage was examined by observation. The result is shown in Table 1.

### Comparative Example 3

The same procedures as those conducted in Comparative Example 1 were conducted except that the container was fully packed with boiled bonito. After the retort treatment, the color tone after the storage was examined by observation. The result is shown in Table 1.

TABLE 1

| | | | | Color change | |
|---|---|---|---|---|---|
| | | | | and | |
| | Gas barrier layer | | | discoloration | |
| | container | cap part | Food | after 1 month | after 3 months |
| Example 1 | polyamide 1 | aluminum foil | carrot | good | good |
| Example 2 | polyamide 1 | aluminum foil | oiled tuna | good | good |
| Example 3 | polyamide 1 | aluminum foil | boiled bonito | good | good |
| Example 4 | polyamide 1 | OMAC | carrot | good | good |
| Example 5 | polyamide 1 | OMAC | oiled tuna | good | good |
| Example 6 | polyamide 1 | OMAC | boiled bonito | good | good |
| Example 7 | polyamide 2 | aluminum foil | oiled tuna | good | good |
| Example 8 | polyamide 2 | aluminum foil | boiled bonito | good | good |
| Comparative | EVOH | aluminum foil | carrot | fair | poor |
| Example 1 | | | | | |
| Comparative | EVOH | aluminum foil | oiled tuna | fair | poor |
| Example 2 | | | | | |
| Comparative | EVOH | aluminum foil | boiled bonito | fair | poor |
| Example 3 | | | | | |

TABLE 2

| | | | | Accumulated amount | |
|---|---|---|---|---|---|
| | Permeability of oxygen | | | of permeation of oxygen | |
| | into container after | | | into container after | |
| | retort treatment | | | retort treatment | |
| | (ml/0.21 atm · day · package) | | | (ml/0.21 atm · package) | |
| | after 1 | after 30 | after 90 | after 30 | after 90 |
| | day | days | days | days | days |
| Example 1 | 0.008 | 0.003 | 0.003 | 0.05 | 0.20 |
| Example 7 | 0.008 | 0.003 | 0.003 | 0.05 | 0.20 |
| Comparative | 0.08 | 0.03 | 0.002 | 0.53 | 0.73 |
| Example 1 | | | | | |

As shown by the results of Example and Comparative Examples, in Examples 1 to 8 in which foods were fully packed into the containers using the specific polyamide for the gas barrier layer as described in the most preferred embodiment to carry out the invention, the foods could be preserved without color change or discoloration. In contrast, in Comparative Examples 1 to 3 in which foods were packed into the containers using EVOH for the gas barrier layer, color change and discoloration of the foods took place although the cap part had the gas barrier property.

As shown by the results of the measurement of the permeability of oxygen after the retort treatment, the increase in the permeability of oxygen due to the retort treatment was small in Examples 1 and 7 in which the specific polyamide was used for the gas barrier layer. In contrast, in Comparative Example 1 in which EVOH was used for the gas barrier layer, the increase in the permeability of oxygen due to the retort treatment was great, and it took a long time for the recovery. Therefore, the accumulated amount of permeation of oxygen into the container was great, showing an inferior barrier property to oxygen. This result is considered to have arisen since the dependency of the gas barrier property on moisture increased due to the use of EVOH having hydroxyl group for the gas barrier layer of the container. Therefore, as shown by the results of Comparative Examples 1 to 3, color change and discoloration of the food took place during storage when the food which must be sterilized by heating was packed in the container.

1. A method for preserving food sterilized by heating which comprises:
sealing the food by using a multilayer container having a layered structure having at least three layers comprising (A) a layer comprising polypropylene as a main component, (B) an adhesive layer comprising an adhesive thermoplastic resin and (C) a gas barrier layer comprising a polyamide resin, which is obtained by polycondensation of a diamine component comprising 70% by mole or more of meta-xylylenediamine and a dicarboxylic acid component comprising 80 to 97% by mole of an α,ω-linear aliphatic dicarboxylic acid and 3 to 20% by mole of an aromatic dicarboxylic acid and has substantially no hydroxyl group, layers (A), (B) and (C) being laminated in this order, and a cap part comprising a gas barrier layer having a permeability of oxygen of 20 ml/m²·day·atm or smaller under an environment of 23° C. and 60% RH; and
sterilizing the sealed food by heating at 80° C. or higher.

2. A method according to claim 1, wherein the gas barrier layer (C) has a coefficient of permeation of oxygen of 1.0 ml·mm/m²·day·atm or smaller under an environment of 23° C. and 60% RH.

3. A method according to claim 1, wherein the gas barrier layer in at least one of the multilayer container and the cap part is an oxygen-absorbing resin layer exhibiting a function of absorbing oxygen.

4. A method according to claim 1, wherein an oxygen-absorbing resin layer is present in at least one of the multilayer container and the cap part.

5. A method according to claim 1, wherein the gas barrier layer in the cap part is a layer comprising at least one layer selected from thin films of metals, inorganic films formed by vapor deposition, layers of ethylene-vinyl alcohol copolymers and layers of polyamide resins.

6. A method according to claim 1, wherein a thickness of the gas barrier layer (C) is 2 to 20% of a thickness of an entire multilayer container.

7. A method according to claim 1, wherein the food is a processed marine product, a processed livestock product, a processed rice product, a liquid food or a fruit.
